(19) United States
(12) Patent Application Publication
(10) Pub. No.: US 2013/0339090 A1
(43) Pub. Date: Dec. 19, 2013

(54) SYSTEM FOR REAL TIME VERIFICATION AND DETECTION OF STOCK SHORTAGES OF GOODS DISPLAYED FOR SALE

(71) Applicants: Valerio Placidi, Porto Potenza Picena (IT); Emanuele Frontoni, Porto San Giorgio (IT)

(72) Inventors: Valerio Placidi, Porto Potenza Picena (IT); Emanuele Frontoni, Porto San Giorgio (IT)

(73) Assignee: GROTTINI LAB S.R.L., Porto Recanati, MC (IT)

(21) Appl. No.: 14/002,796

(22) PCT Filed: Jun. 17, 2011
(86) PCT No.: PCT/IT2011/000206

§ 371 Date: Sep. 3, 2013

(30) Foreign Application Priority Data
Mar. 8, 2011 (IT) AN2011A000033

(51) Int. Cl. G06Q 30/02

(52) U.S. Cl. CPC G06Q 30/0202
USPC 705/7.31

(57) ABSTRACT

Real time stock break survey system for products displayed on sale, comprising at least one position sensor means or presence sensor means positioned on the display surface nearby the group of products under stock break survey, at least one transmission means to transmit the data detected by said sensor means and notified to said transmission means, and a data processing and management unit provided with a software program for the management of the detected data, and communicating with said transmission means.

The present invention relates to a system for real-time verification and detection of availability and location of goods displayed for sale, and in particular stock shortages related to shelving in commercial outlets such as supermarkets, hypermarkets or any other retail area, in order to monitor the display of products on said shelving.

Furthermore, the system has a section where a whole series of data is processed and stored in order to carry out and provide statistical analyses relating to the life of the products on the shelves, so as to be able to strategically assess how consumer habits vary over time and geographically, comparing the data gathered over different periods and at different points of sale (belonging to the same chain but in different locations).

Therefore, the system according to the present invention is a useful and essential tool for the management of goods displayed for sale, enabling the number of products present on a specific shelf and/or display stand to be assessed and warning the point of sale staff when there is a stock shortage.

A stock shortage occurs when a certain product runs out on a particular shelf or on a self-service/non-self-service display stand, and the situation remains so until the point of sale staff replenish the stock.

This represents poor quality of service for the consumer who is deprived of the possibility of purchasing that particular product and must fall back on a product that is similar but of another brand, or go to another point of sale to remain loyal to the brand and fully satisfy his/her requirements.

The usual widespread practice in the large-scale retail trade is to check the state of the shelves at least once a day, which not only takes a considerable amount of time but also fails to prevent the risk of products being missing from the shelves for a whole day.

Systems for checking and detecting stock shortages also exist, and these include: manually checking the spaces allocated to the display of goods, checking and comparing the POS (Point Of Sale) data, keeping a continuous inventory of said goods, and adopting product- or shelf-weighing systems.

However, none of these systems completely fulfils its function, and none guarantees the objectivity of the data or gives a real-time warning of stock shortages.

Therefore, the primary aim of the present invention is to provide a system for real-time verification and detection of stock shortages of products displayed for sale, in order to monitor the display of the products on said shelves.

A further aim of the present invention is to obtain a statistical analysis of the products in order to strategically assess consumer habits and how they vary depending on the period and point of sale under consideration.

Accordingly, the object of the present invention is a system for real-time detection of stock shortages of goods displayed for sale, including at least one position-detection sensor means located on the display shelf near the group of products for which stock shortage is to be detected, at least one means for transmitting the data detected by said sensor means and sent to said transmission means, and at least one data processing and management unit equipped with a software program to manage the data collected and communicating with said transmission means.

These and other features of the invention, and the advantages that derive therefrom, will emerge from the following detailed description of a preferred embodiment, shown by way of a non-limiting example, with reference to the accompanying drawings, in which:

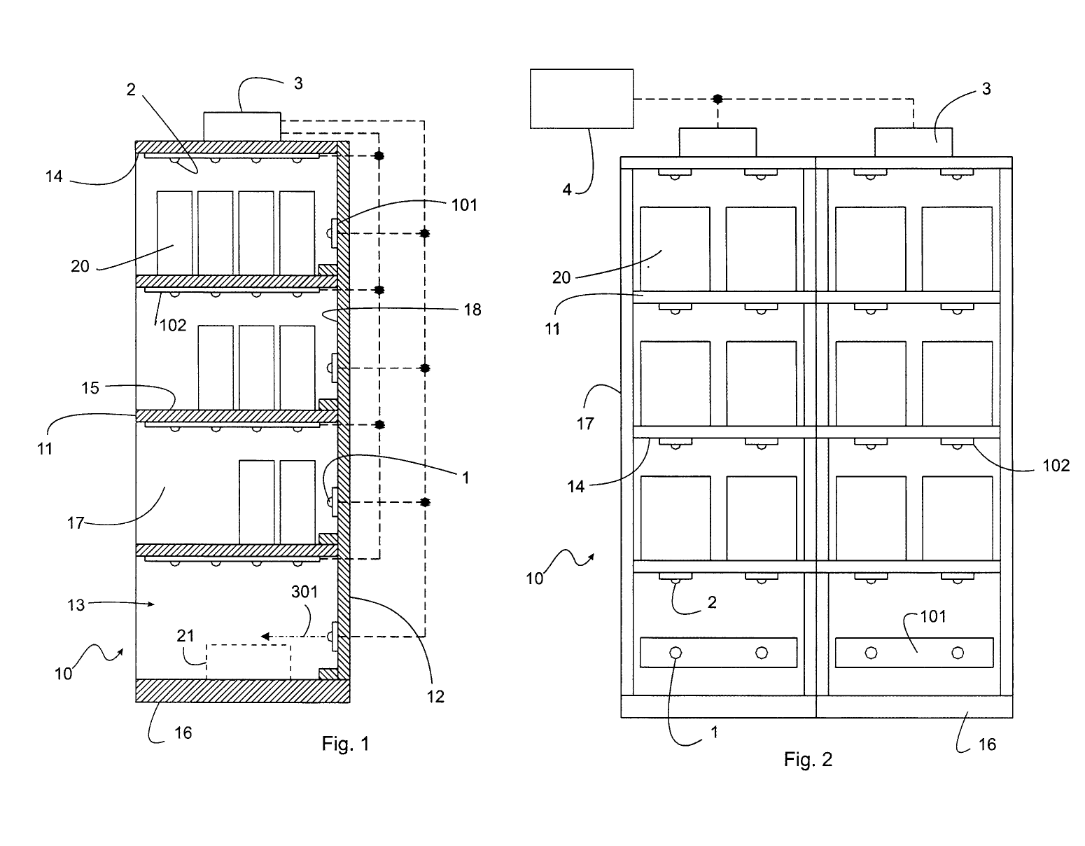

FIG. 1 is a sectional view of a shelf unit on which an embodiment of the system according to the present invention is installed;

FIG. 2 is a front elevation of the embodiment of the system shown in FIG. 1.

FIG. 1 shows a display shelf unit indicated by reference numeral 10 in the figure.

The shelf unit 10 comprises a series of shelves 11, connected laterally to sides 17 and backwardly to a back panel 12; the back panel 12 and the sides 17 are connected at the bottom to the base 16. In this way, the shelf unit has formed a plurality of chambers 13 in which the products 20 can be accommodated. On the top wall 14 of each chamber 13 there is a supporting means 102 which supports a plurality of sensors 2; a similar supporting means 101 supports the sensors 1 on the wall 18 of the back panel 12. The sensors 1 and 2 of said shelf unit 10 all communicate with a transmission means 3 located on the top wall of the shelf unit 10.

FIG. 2 shows two contiguous shelf units equipped with the system according to the present invention; the same parts are denoted by the same reference numerals. The figure shows the presence of a central control unit 4 connected to the transmission means 3 of the two contiguous shelf units.

The operation of the system according to the present invention will become clear from the following description. The products 20 are positioned in the chambers 13 of the shelf units 10, and the sensors 1 detect their presence; the sensors that can be used for this purpose can generally be position-detection sensors or presence sensors, such as infrared sensors, capacitive sensors, volumetric sensors, optical sensors, video cameras or the like.

The sensors 1 positioned on the back wall 18 simply detect when the row of products 20 arranged in front of them has been used up; advantageously, on the supporting means 101, as many sensors 1 will be positioned as there are rows of products intended to occupy the chamber 13 in which said sensors 1 are positioned. The supporting means can be connected to the back panel 12 of the shelf unit 10 by the appropriate fixing means; in particular, if the frame of the shelf unit 10 is mainly made of metal, the supporting means 101, and similarly also supporting means 102, will be fitted with magnetic means, preferably of the permanent magnet type, for the connection to said shelf unit. The sensors 1 detect when, as in the lowest chamber of the shelf unit 10, the product is no longer in front of them. The information thus detected is sent to the transmitting means 3 where it is processed, being characterised by the appropriate identification data indicating the position of the shelf on which the product has run out, i.e. the stock shortage, and then transmitted via GPRS, zigbee, RF reception/transmission or similar systems, to a central processing unit 4 which signals the product's stock shortage status to the product stock management system.

At this point, the system signals to the point of sale staff or those appointed to receive the information about stock shortage, who will arrange for the product on the shelf to be replenished and, simultaneously, the system will process and store the information relating to the stock shortage, i.e. the permanence and absence time of the product from the display shelf unit; these data represent an important parameter for product sales statistics.

The data management and processing software receives, through a GPRS or ethernet or similar connection, a string of data whereby it is possible to identify the central processing unit 4 which transmitted said string of data.

Furthermore, said string of data includes an identification code of the supporting means detected by the central processing unit 4, and describes the operation status of each supporting means (OK, Error, Battery Low) as well as the status of each sensor associated therewith.

The software is capable of recognising the information contained in this string and filtering any incorrect communications (e.g. wrong number of sensors per supporting means, very high number of status changes) that may occur as a result of hardware malfunctions.

The data thus obtained are analysed and compared with the data in the database and, if a sensor detects a change in status compared with the previous reading, two situations can have arisen: if the product was previously present and is now no longer so, the software associates a product shortage to the position of that specific sensor; by contrast, if previously the product was not present and now it is, the software cancels the stock shortage previously detected.

If said software finds no variations between two subsequent readings, it ignores the data pertaining thereto.

After updating the status of each sensor, the software checks whether the position shortages detected by said sensors also involve a stock shortage, i.e. whether any sensors targeted to products of the same type detect the presence of the product.

In fact, the sensors 2 are capable of detecting more thoroughly the amount of products existing on the shelf unit in a given row; this detection system allows the sales data detected at the tills to be cross-referenced with those of the display unit, thereby providing another important statistical database.

Moreover, as shown in the lowest chamber 13 of the shelf unit 10 in FIG. 1, if a product is running low or has run out, as indicated by the dotted lines 21, the system equipped only with sensor 1 would detect the absence of product on that shelf, given that the product would not interfere with the beam 301 of the sensor; in this way, however, the detection cross-reference inside the chamber 13 using the data detected by the sensors 2 and that detected by the sensors 1 provides a true picture of the shelf's supply status.

The software signals the stock shortage by sending an email and/or SMS text to the appointed recipients in a configuration page containing the information relating to the product in question, its location within the point of sale, and the time at which the shortage occurred. At the same time, a special table in the database is updated.

This last stage also occurs if a shortage is replenished.

In parallel to this, the software is capable of enabling an authorised user to configure the number of bars and sensors used, and the respective associations with the products in the planogram, i.e. the diagram showing the arrangement of the products on the shelves of the shelf units and on the display stands.

Advantageously, said sensor means and said transmission means can also be powered by batteries, so as to avoid wiring up the shelf units, which usually may be frequently moved.

The information gathered by the sensors is sent to a data management and processing board, via a modem or similar devices for the wireless transmission of data, installed on said metal bars where the sensors are also installed.

The system also ensures that the information gathered by sensors 2 and 1 is sent to the transmission means 3 either through a physical connection formed by internal wiring between the bars and transmission means 3 or in a wireless mode, by means of a modem with a wireless data transmission technology (zigbee, RF, etc.).

The data management and processing card, i.e. the transmission means 3, after having received the information from the sensors, will transmit it to the processing unit 4 which, via the data processing and management software, will send the information to a cellular telephone by a text message or to an email address via an email, or by using another method of sending data (fax, notification messages via LANs, etc.), thus informing the appointed individuals of the stock shortage.

All of the information processed and sent by the data processing unit 4 will be stored and, on request, can be processed and used as a report which will provide a summary thereof divided according to product code or category, for each point of sale or groups of points of sale, for each day of the week or for several weeks, with the possibility of customizing the report according to product/location/time.

Moreover, the data processing and management software offers the possibility of obtaining, in real time, a series of data about the current situation of each point of sale, listing the stock shortages not yet replenished or those that have been replenished by ordering them as a matter of urgency, or showing these data as graphs, always updated in real time, for the weekly trend of each product, so as to detect obvious critical situations, the distribution of stock shortages among the various products, the OOS (Out of Stock) percentages of each product compared to the shop's total, even weighting the facing number of each one, and so on.

1-10. (canceled)

11. A stock survey system for products disposed in exposure surfaces, the system comprising:
at least one sensor disposed in proximity to the products, and positioned to sense the presence or absence of such product in at least a portion of the exposure surface;
a processing unit;
a communication link for coupling and transmitting data between the processing unit and the at least one sensor;
software to cause the processing unit to store sensor transmitted data, and obtain a statistical analysis of the data to assess the habits of consumers and the average life of at least one product on a respective exposure surface.

12. A system as claimed in claim 11, wherein the processing unit is configured to signal a stock shortage.

13. A system as claimed in claim 12, wherein the signal comprises an email, a message directed to a mobile telephone, a facsimile message, or any combination thereof.

14. A system as claimed in claim 11, wherein the exposure unit has a rear side, and wherein the at least one sensor is positioned on the rear side of the exposure surface.

15. A system as claimed in claim 11 wherein the at least one sensors is selected from a position sensor, a presence sensor, an infrared sensor, a capacitive sensor, a volumetric sensor, a n optical sensor, a video cameras or any combination thereof.

16. A system as claimed in claim 11, wherein the sensor is powered by at least one battery.

17. A system as claimed in claim 11, further comprising a plurality of sensors arranged such that at least one sensor is disposed behind each row of products on the exposure surfaces.

18. A system as claimed in claim 11, further comprising a plurality of sensors such that at east one sensor is disposed above each row of products on the exposure surface.

19. A system as claimed in claim 11, further comprising a plurality of sensors, such that at least one sensor is disposed behind each row of products on the exposure surfaces, and at least one sensor is disposed above each row of products on the exposure surface.

20. A system as claimed in claim 11, wherein the at least one sensor is disposed to detect absence of a correlated product from at least one row of products on the exposure surfaces.

21. A system as claimed in claim 11, wherein the at least one row of products is disposed above at least one other row of products.

22. A system as claimed in claim 11, wherein the at least one sensor is positioned to detect when a quantity of a correlated product from at least one row of products on the exposure surfaces falls below a predetermined level.

23. A system as claimed in claim 11, wherein the exposure surface comprises shelves or shelving units.

24. A system as claimed in claim 11, wherein the software perform a correlation between the sensor data and data from till machines for tracking sales of the products.

25. A system as claimed in claim 11, wherein the statistical analysis comprises comparison of recently sensed data with existing database data for detecting trends related to at least one product.

26. A system as claimed in claim 11, wherein the statistical analysis further comprises analysis relating to information selected from consumer habits variation over time, consumer habit variations over varied geography, consumer habit variations between different points of sale, and any combination thereof.
